(19) United States
(12) Patent Application Publication
(10) Pub. No.: US 2002/0047649 A1
(43) Pub. Date: Apr. 25, 2002

(54) Apparatus for illuminating a portable electronic or computing device

(76) Inventors: Gilbert Fregoso, Santa Ana, CA (US); David Naghi, Los Angeles, CA (US)

Correspondence Address: LYON & LYON LLP, 633 WEST FIFTH STREET, SUITE 4700, LOS ANGELES, CA, 90071, US

(21) Appl. No.: 09/876,250

(22) Filed: Jun. 6, 2001

Related U.S. Application Data
(63) Continuation-in-part of application No. 09/765,897, filed on Jan. 16, 2001.
(63) Continuation-in-part of application No. 09/712,692, filed on Nov. 13, 2000.
Application No. 09/712,692 is a continuation of application No. 09/330,322, filed on Jun. 11, 1999.
(60) Provisional application No. 60/176,110, filed on Jan. 14, 2000.

(51) Int. Cl. G05F 1/00

(52) U.S. Cl. 315/362; 315/291

(57) ABSTRACT

An apparatus for illuminating a portable electronic or computing device includes a plug for plugging the apparatus into a port of the device, a body connected to the plug, and an illumination device attached to the body and to be electrically connected to the port through the plug and the body. The illumination device includes one or more light emitting diodes to illuminate the portable electronic device. The one or more light emitting diodes require a required power to be effectively illuminated. The illumination device is powered by a power source of the portable electronic or computing device when the apparatus is plugged into the port. A circuit delivers the required power to the one or more light emitting diodes regardless of the power delivered at the port.

### CROSS-REFERENCE TO RELATED APPLICATIONS

This application is a continuation-in-part application of U.S. Ser. No. 09/765,897 filed Jan. 16, 2001, which claims the benefit of provisional application Ser. No. 60/176,110 filed Jan. 14, 2000; and a continuation-in-part application of U.S. Ser. No. 09/712,692 filed Nov. 13, 2000, which is a continuation of U.S. Ser. No. 09/330,322 filed Jun. 11, 1999, now U.S. Pat. No. 6,186,636.

### FIELD OF THE INVENTION

The present invention is in the field of lighting devices for portable electronic or computing devices.

### BACKGROUND OF THE INVENTION

Compact electronic devices with a viewing screen or keypads have become very common and quite popular. Such devices have been popular for a number of years in connection with hand-held, portable, battery-powered gaming devices. Well-known examples of such devices are the GAME BOY® and GAME BOY ADVANCE™ devices sold by Nintendo. More recently, other electronic devices have also included viewing screens, such as, but not limited to, portable video cameras, digital cameras, cellular phones, internet phones, and Portable Digital Assistants (PDAs). Of course, portable computers have long had viewing screens. Although the complexity and cost of such devices can vary greatly, it is common for such devices to use a generally flat, liquid crystal display screen.

Flat, liquid crystal display screens work very well in a well-lit area. However, when such devices are used in dimly lit areas, or at night, it can be difficult, if not impossible, for a user to see anything in the viewing screen. This problem is magnified when such a screen is used in a device that is meant to be portable, and especially when it is a small device.

If a portable device is sufficiently complex, and generally more expensive, such as a portable laptop computer, the device can include lighting within the actual device. An example of such lighting is a portable laptop computer with a backlit screen. However, this solution is not always economically practical, nor does it necessarily solve the problem in smaller devices. Also, if an electronic device does not have a viewing screen, then this option is not even available.

To solve this problem, especially in connection with hand-held, portable, battery-powered gaming devices, a number of different solutions have been proposed. Such solutions have typically included add-on devices with their own source of electrical power. These devices can be designed to fit onto the electronic device or be designed for use in connection with the electronic device. However, because such devices use their own source of electrical power, they tend to be rather bulky and heavy. In addition, the second source of electrical power increases cost and creates the possibility of another source of power failure.

The solve these problems, the inventors of the present invention have developed an illumination apparatus for a portable electronic or computing device that may plug into a port of the device to receive power from a power source associated with the device to illuminate a screen of the device, any other part of the device, or an object associated with the device. The inventors of the present invention recognized that the power supplied at the port for some portable electronic or computing devices may be too low to effectively illuminate the illumination apparatus, may be too high so as to damage the illumination apparatus, and/or may vary between a power that is too low and/or a power that is too high. For example, the inventors recognized that the GAME BOY ADVANCE™ portable handheld video game device includes an output voltage at the port of approximately 3.2 V when used with newer video games, but an output voltage of approximately 5 V when used with older video games designed for the GAME BOY® portable handheld video game device. However, a white light emitting diode (LED) that may be used with an exemplary illumination apparatus developed by the inventors has been determined by the inventors to require a minimum of 3.6 to 4.0 V to be illuminated effectively. Thus, with the new video games, the output power at the port is too low, and with the older video games, the output power at the port may be too high. If the LED receives too little power, the diode will have no light output or poor light output that begins to weaken almost immediately. If the LED receives too much power, the diode may be damaged or too much heat may be emitted by the apparatus.

Accordingly, the inventors of the present invention recognized that a need exists for an illumination device for a portable electronic or computing device, especially for a portable handheld video game device, that delivers an optimal amount of power to an illumination device (e.g., white LED) of the apparatus regardless of the output power (i.e., too low, too high, varied) at the port of the portable electronic or computing device.

### SUMMARY OF THE INVENTION

Accordingly, an aspect of the invention involves an illumination device for a portable electronic or computing device, especially for a portable handheld video game device, that includes a circuit for delivering a generally constant amount of power to an illumination source of the illumination device regardless of the output voltage from a port of the portable electronic or computing device. The circuit enables the production of light from an illumination device that is efficient and cool-burning. The circuit comprises an inductive storage device, a switching regulator device, a rectifier and filter and, a current sensing device in a closed loop feedback system. The use of an inductive storage device can allow the circuit to function using a low voltage input. The switching regulator device can monitor and regulate the power applied to the LEDs, protecting the diodes. The circuit can illuminate a number of LEDs with a low voltage input. In a preferred embodiment, the subject system can be approximately 97% efficient.

Another aspect of the invention involves an apparatus for illuminating a portable electronic or computing device. The apparatus includes a plug for plugging the apparatus into a port of the device, a body connected to the plug, and an illumination device attached to the body and to be electrically connected to the port through the plug and the body. The illumination device includes one or more light emitting diodes to illuminate the portable electronic device. The one or more light emitting diodes require a required power to be effectively illuminated. The illumination device is powered by a power source of the portable electronic or computing device when the apparatus is plugged into the port. A circuit delivers the required power to the one or more light emitting diodes regardless of the power delivered at the port.

A further aspect of the invention involves an apparatus for illuminating a display screen of a handheld portable video game device having a port in electrical connection with a power source for delivering power through the port. The apparatus includes a plug for plugging the apparatus into the port, a body connected to the plug, and an illumination device attached to the body. The illumination device is electrically connected to the port through the plug and the body. The illumination device includes one or more light emitting diodes to illuminate the display screen. The one or more light emitting diodes require a required power to be effectively illuminated. The illumination device is powered by the power source when the apparatus is plugged into the port. A circuit delivers the required power to the one or more light emitting diodes regardless of the power delivered at the port.

These and further objects and advantages will be apparent to those skilled in the art in connection with the drawing and the detailed description of the preferred embodiment set forth below.

### BRIEF DESCRIPTION OF THE DRAWINGS

FIG. 1 is a schematic representation of an embodiment of an illumination device.

FIG. 2 shows an embodiment of a circuit that may be used with the illumination device.

FIG. 3 shows another embodiment of a circuit that may be used with the illumination device.

### DETAILED DESCRIPTION OF THE PREFERRED EMBODIMENT

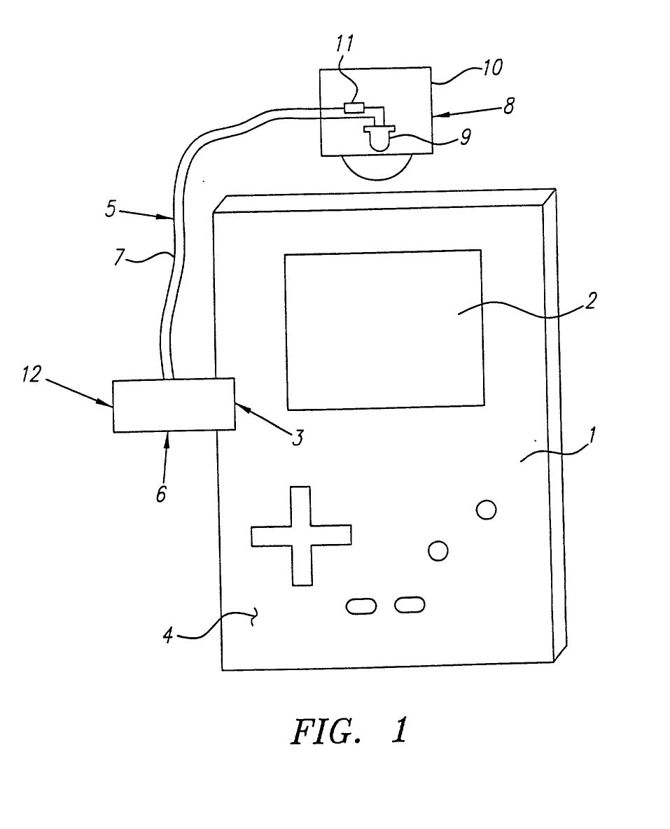

FIG. 1 illustrates an embodiment of the present invention used with a portable electronic game device, such as a GAME BOY® device. Although this drawing depicts a portable electronic game device, the invention is adaptable to any portable electronic device that has a utility power jack or port in electrical connection with a power source, such as, but not by way of limitation, a cellular phone, an internet phone, a laptop computer, a Personal Digital Assistant (PDA), a digital camera, and a digital video camera.

In the preferred embodiment shown in FIG. 1, the electronic device 1 has a viewing screen 2, a power source and a utility power jack or port. The power source and utility power jack or port are not visible and are shown generally as 3 and 4, because their location and configuration will vary depending upon the design of a given portable electronic device. The power source 3 may include one or more batteries (e.g., disposable, rechargeable, solar-powered), fuel cells, or the like. The power source 3 may be associated with the device 1 in a number of different ways such as, but not by way of limitation, the power source 3 may be completely contained within a power source compartment of the device 1, removably attachable to contacts in the battery compartment, or removably attachable to an input power port of the device 1. The power source 3 may or may not be augmented by a plug-in capability to a non-portable power source, such as a wall outlet.

An embodiment of the illumination apparatus, shown generally as 5, includes a plug, shown generally as 6, for plugging the illumination apparatus 5 into the utility power jack or port 4 of the electronic device 1. The exact configuration of the plug 6 should be designed so as to mate with the utility power jack or port 4 and create a mechanical and electrical connection between the utility power jack or port 4 and the plug 6 when the apparatus 5 is plugged into the electronic device 1.

The illumination apparatus 5 also includes a body 7 and an illumination device 8. The body 7 connects the illumination device 8 to the plug 6, and the body 7 is preferably comprised of a flexible arm. The illumination device 8 is electrically connected to the utility power jack 4 through the plug 6 and the body 7 so that the illumination device 8 is powered by the power source 2 when the illumination apparatus 5 is plugged into the electronic device 1. The electrical connection between the illumination device 8 and the plug 6 can be by any suitable means, such as by a wire (not shown). It is especially preferred that the body 7 can be adjusted, when the apparatus 5 is plugged into the utility power jack 4, to adjust the height and/or the angle of the illumination device 8 relative to the electronic device 1.

In the preferred embodiment of the present invention, the illumination device 8 is comprised of one or more light emitting diodes (LEDs) 9 housed in a case housing 10. The housing 10 can also include suitable electronics, such as a resistor 11, or a regulator (not shown) for varying the intensity of light given off by the LED. In an especially preferred embodiment, the one or more LEDs 9 are one or more white LEDs. The housing can also include additional features, such as, but not limited to, a diffuser lens 9, or a magnifier (not shown).

When the plug 6 of the illumination apparatus 5 is plugged into the utility power jack 4 of the electronic device 1, the plug 6 necessarily occupies the connection that the utility power jack 4 would otherwise provide to a user of the electronic device 1. Because a user of the electronic device 1 might need to connect some other device to the utility power jack 4, it is especially preferred that the plug 6 be constructed so as to include a second utility power jack or port 12. The second utility power jack or port 12 is adapted to receive a second plug and provide a mechanical and electrical connection for the second plug equivalent to that which is provided by the first utility power jack or port 4. Thus, the second utility power jack 12 will provide electrical communication for the second plug with the first utility power jack or port 4 when the second plug is plugged into the first plug 6 and the first plug 6 is plugged into the first utility power jack or port 4.

The present invention is also adaptable to a portable computing device with a display screen that is not illuminated by the portable computing device. In such an embodiment, the illumination apparatus is plugged into a utility port of the computing device in electrical connection with a power source instead of the utility power jack or port 4 of the electronic device 1. In such a device, the utility port can be any port that allows connection of additional products or communication devices, or cables, or any additional accessory or product. The illumination apparatus can have a second utility port adapted to receive a second plug that is in electrical communication with the first utility port when the second plug is plugged into the first plug and the first plus is plugged into the first utility port. In all other respects, the structure and function of the illumination apparatus would be the same as for the illumination apparatus 5 described above in connection with electronic device 1.

As described above, the inventors of the present invention recognized that in certain portable electronic or computing devices such as the GAME BOY ADVANCE™ portable handheld video game device, the output voltage from the port of the device 1 may vary. For example, the output voltage of the GAME BOY ADVANCE™ portable handheld video game device may vary depending on the type of video game that is played with the device. Older video games designed for the GAME BOY® dictate an output voltage at the port of the GAME BOY ADVANCE™ of approximate 5 V, but new video games designed specifically for the GAME BOY ADVANCE™ dictate a lower output voltage at the port of the GAME BOY ADVANCE™ of approximately 3.2 V. A white light emitting diode requires a minimum of 3.6 to 4.0 V to be illuminated effectively. Too much power delivered to the one or more white light emitting diodes 9 may damage the diode(s). Too much power delivered to the one or more white light emitting diodes 9 may cause the diode(s) to have no light output or poor light output that begins to weaken almost immediately.

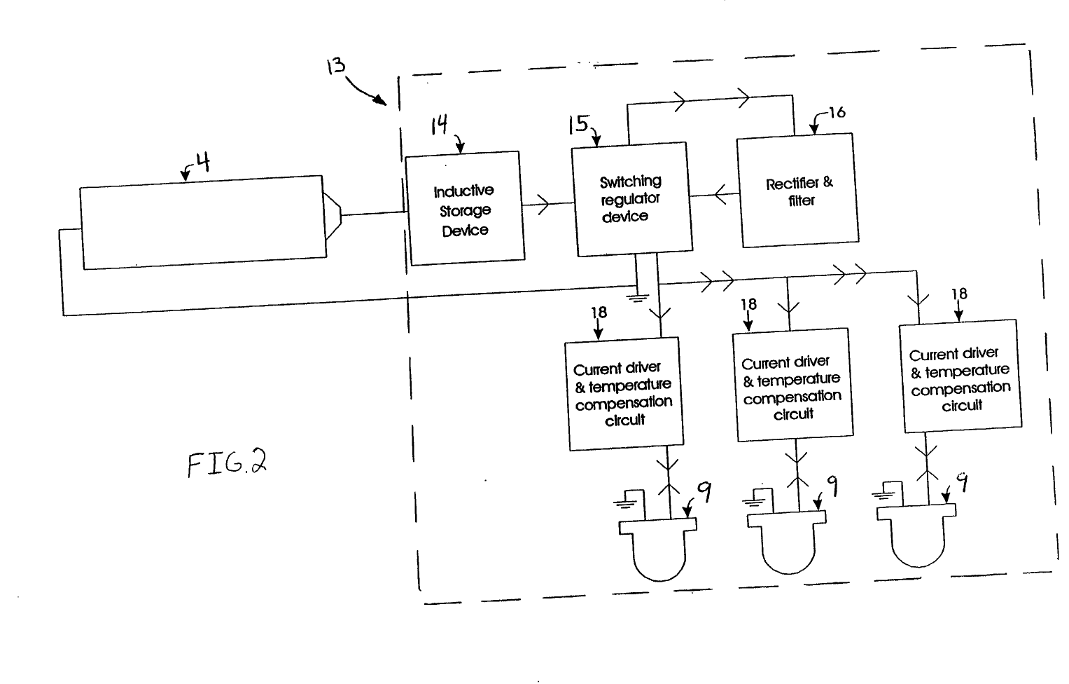

Accordingly, with reference to FIG. 2, an embodiment of an efficient circuit 13 that may be used in the illumination apparatus 5 for driving the one or more LED(S) 9 at an optimum power level, regardless of the power level available at the port 4, is shown. The circuit 13 may utilize an inductive storage device that allows the circuit 13 to function with low voltage input. Further, a switching circuit may be used in a closed loop feedback system to monitor and regulate the power supplied to the LED(s), protecting the diode(s) and allowing them to burn for extended periods. The circuit 13 is preferably located in the plug 6 of the illumination apparatus 5 or a compartment adjacent the plug 6; however, the circuit 13 may be located in other areas of the illumination apparatus 5 such as, but not limited to, the body 7 or case housing 10.

The power supply 4 (e.g., one or more disposable batteries, rechargeable batteries, fuel cells, etc.) associated with the device 1 supplies DC current to an inductive storage device 14 such as an inductor. Preferably, the inductive storage device 14 is wire wound with an inductance between about 22 and 220 micro henries. Wire wound inductors reduce resistance, conserving energy from the power supply 4 and reducing heat emitted from the illumination apparatus 5.

Current from the inductive storage device 14 goes to a high speed switching converter and regulator device 15. In one embodiment, the switching regulator device 15 may be an integrated circuit (IC) having a reference voltage source, an oscillation circuit, a power MOSFET (metal oxide semiconductor field-effect transistor), and an error amplifier. The switching regulator device 15 may be a CMOS PWM/PFM-control step-up switching regulator. In an alternative embodiment, the circuit 13 may include other types of pulse-width modulation switching regulators or a resonant-type modulation switching regulator.

The inductive storage device 14 converts DC current supplied by the power source 4 to AC current. The current leaving the switching regulator device 15 is likewise AC current. This AC current can be rectified and filtered to DC current through a rectifier and filter 16. In a specific embodiment, a Schottky diode can be used as the rectifier and filter 16. A Schottky diode can provide a fast reverse recovery time and a low forward voltage drop. The rectified and filtered current is fed back to the switching regulator device 15 where it can be controlled and monitored for the proper voltage output.

The rectified and filtered DC output is sent to a current sensing device, which controls the current sent to the LED(s) 9. In one embodiment, the current sensing device is a current driver and temperature compensation circuit 18 having an error amplifier, a current sensing resistor, and at least two reference voltage resistors. The current sensing device may include a transistor used as a power driver. The current sensing and temperature compensation circuit 18 controls the temperature, protecting the LED(s) 9 from thermal runaway and allows the LED(s) 9 to be driven at or near maximum current without the LED being destroyed.

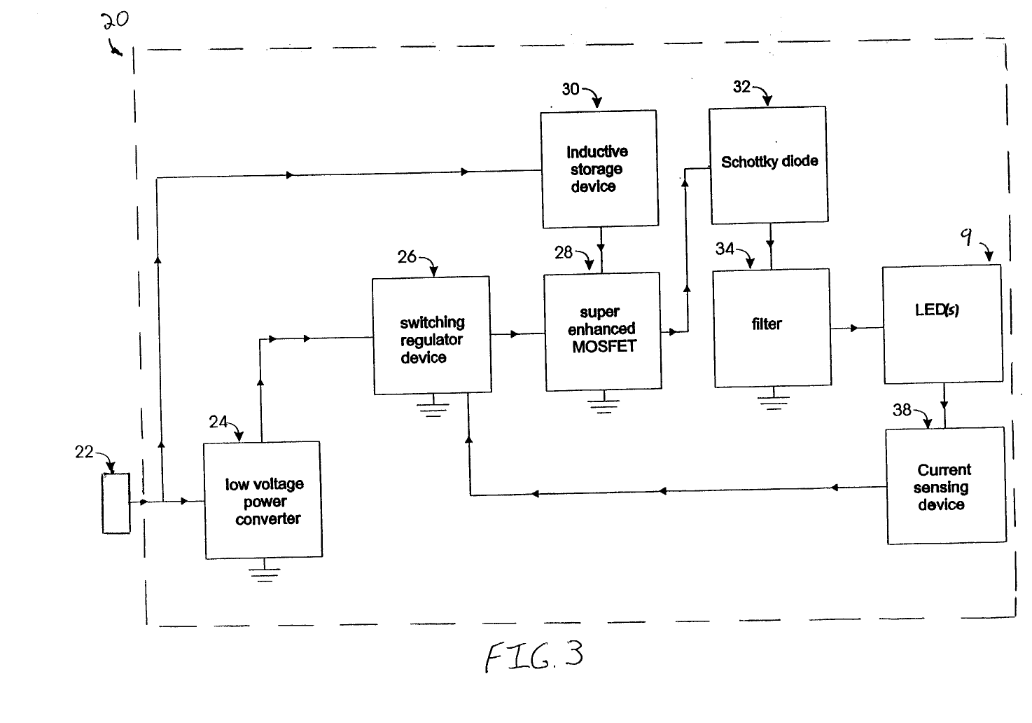

With reference to FIG. 3, an efficient circuit 20 constructed in accordance with another embodiment of the invention that may be used in the illumination apparatus 5 for driving the one or more LED(s) 9 at a generally constant voltage and current, regardless of the power level available at the port 4, is shown. This circuit 20 is an enhanced version of the circuit 13 shown in FIG. 2, and may use a lower voltage input to drive more LEDs 9. In this circuit 20, a switching regulator device 26 may include a programmable reference voltage source and may be driven by a low voltage power converter. The switching regulator device 26 may also have an external super enhanced MOSFET 28.

A DC power input 22, which in the embodiment shown may be the voltage at the port 4 and range from 0.8 to 5 V, provides power to an inductive storage device 30. Within the inductive storage device 30, DC current is converted into AC current. The AC current is converted to DC current by a rectifier 32, which may be a Schottky diode. The current may then be filtered at 34 before being applied to the one or more LEDs 9. A current sensing device 38 may feed a signal reference voltage back to the switching regulator device 26, providing current load information for regulating the circuit 20. Preferably, the current sensing device 38 may include a resistor having a resistance of less than about 15 ohms.

The switching regulator device 26 monitors the signal from the current sensing device 38 and regulates the power delivered to the circuit 20. In one embodiment, the switching regulator device 26 requires about 3 V of power.

The circuit 20 may include a low voltage power converter circuit 24 to provide the power necessary to run the switching regulator device 26. In the embodiment shown, the low voltage power converter 24 may produce 3 V and about 20 mA when supplied with as little as 0.8 V input (e.g., via the port 4).

The switching regulator device 26 may incorporate a programmable reference voltage source, an oscillation circuit, and an error amplifier. The external super enhance MOSFET 28 is controlled by the switching regulator device 26 and loads the inductive storage device 30. The super enhanced MOSFET is a very efficient transistor and requires very little current to operate. In a further embodiment, the switching regulator device 26 may also have a high current power converter capable of driving even more LEDs 9 than the number shown.

Thus, when the illumination apparatus 5 is connected with the power source 9 through the port 4, the circuit 13, 20 of the illumination apparatus 5 delivers the required or optimal power to the LED(s) 9 of the illumination apparatus 5 regardless of the output voltage and current available at the port 4 (e.g., regardless of whether the output voltage and current are too low, too high, or varied). The circuit 13, 20 efficiently uses the power available at the port 4 to drive the LED(s) 9, conserving energy from the power source 9 and emitting minimal or no heat.

Although the circuit 13, 20 has been described as controlling the delivery of output power, regardless of the input power, to one or more LEDs 9, the circuit 13, 20 may be used to drive one or more illumination devices other than LEDs and may be used to drive one or more other loads that require an optimal amount of power other than illumination devices. The circuit 13, 20 may be used with a variety of portable electronic or computing devices, or variety of other types of devices that include a port, connector, contact, or other element through which power is delivered. The circuit 13, 20 may be used with devices that deliver too little power, too much power or varying amounts of power through the port, connector, contact, or other element.

It will be readily apparent to those skilled in the art that still further changes and modifications in the actual concepts described herein can readily be made without departing from the spirit and scope of the invention as defined by the following claims.

What is claimed is:

1. An apparatus for illuminating a portable electronic or computing device having a port in electrical connection with a power source for delivering power through the port, comprising:
a plug for plugging the apparatus into the port;
a body connected to the plug;
an illumination device attached to the body and to be electrically connected to the port through the plug and the body, the illumination device including one or more light emitting diodes to illuminate the portable electronic device, the one or more light emitting diodes requiring a required power to be effectively illuminated, the illumination device being powered by the power source when the apparatus is plugged into the port; and
a circuit to deliver the required power to the one or more light emitting diodes regardless of the power delivered at the port.

2. The apparatus of claim 1, wherein the required power is at least about 3.6 to about 4 V.

3. The apparatus of claim 1, wherein the circuit is adapted to deliver at least about 3.6 to about 4 V to the one or more light emitting diodes when power at the port varies from about 3.2 V to about 5 V.

4. The apparatus of claim 1, wherein the circuit is adapted to deliver at least about 3.6 to about 4 V to the one or more light emitting diodes when power at the port is about 3.2 V.

5. The apparatus of claim 1, wherein the circuit is adapted to deliver at least about 3.6 to about 4 V to the one or more light emitting diodes when power at the port is about 5 V.

6. The apparatus of claim 1, wherein the circuit is adapted to deliver at least about 3.6 to about 4 V to the one or more light emitting diodes when power at the port is less than 3.6 V.

7. The apparatus of claim 1, wherein the circuit is adapted to deliver at least about 3.6 to about 4 V to the one or more light emitting diodes when power at the port is at least about 0.8 V.

8. The apparatus of claim 1, wherein the apparatus is adapted for use with a handheld portable video game device.

9. The apparatus of claim 1, wherein the handheld portable video game device has a non-backlit display screen.

10. The apparatus of claim 1, wherein the circuit includes an inductive storage device, a switching regulator device, a rectifier, a filter, and a current sensing device.

11. The apparatus of claim 10, wherein said inductive storage device is wire wound with an inductance between about 22 and 220 micro henries.

12. The apparatus of claim 10, wherein said switching regulator device comprises: a reference voltage source; an oscillation circuit; an error amplifier; and a power MOSFET.

13. The apparatus of claim 10, wherein said switching regulator device is a CMOS PWM-PFM-control step-up switching regulator.

14. The apparatus of claim 10, wherein said rectifier is a Schottky diode.

15. The apparatus of claim 10, wherein said current sensing device is a current driver and temperature compensation circuit comprising an error amplifier, a current sensing resistor and at least two reference voltage resistors.

16. The apparatus of claim 15, wherein said current driver and temperature compensation circuit further comprises a transistor as a power driver.

17. The apparatus of claim 10, further comprising a low voltage power converter circuit.

18. The apparatus of claim 17, wherein said low voltage power converter circuit produces 3 volts and 20 milliamps when supplied with at least 0.8 volts input.

19. The apparatus of claim 17, wherein said switching regulator device comprises: a programmable reference voltage source; an oscillation circuit; and an error amplifier.

20. The apparatus of claim 19, further comprising a super enhanced MOSFET.

21. The apparatus of claim 1, wherein said circuit is at least about 70% to about 99 % efficient.

22. The apparatus of claim 1, wherein said circuit is at least about 90% efficient.

23. The apparatus of claim 1, wherein said circuit is at least about 97% efficient.

24. The apparatus of claim 10, wherein said inductive storage device is wire wound with an inductance between about 22 and 220 micro henries, said switching regulator device is a CMOS PWM/PFM-control step-up switching regulator, said rectifier is a Schottky diode, and said current sensing device is a current driver and temperature compensation circuit comprising an error amplifier, a current sensing resistor, at least two reference voltage resistors, and a transistor as a power driver.

25. The apparatus of claim 20, wherein said switching regulator device comprises a programmable reference voltage source, an oscillation circuit, and an error amplifier, and said circuit further comprises a low voltage power converter circuit capable of producing 3 volts and 20 milliamps when supplied with a least 0.8 volts input and a super enhanced MOSFET.

26. The apparatus of claim 1, wherein the one or more light emitting diodes includes one or more white light emitting diodes.

27. An apparatus for illuminating a display screen of a handheld portable video game device having a port in electrical connection with a power source for delivering power through the port, comprising:
a plug for plugging the apparatus into the port;
a body connected to the plug;
an illumination device attached to the body and to be electrically connected to the port through the plug and the body, the illumination device including one or more light emitting diodes to illuminate the display screen, the one or more light emitting diodes requiring a required power to be effectively illuminated, the illumination device being powered by the power source when the apparatus is plugged into the port; and
a circuit to deliver the required power to the one or more light emitting diodes regardless of the power delivered at the port.

28. The apparatus of claim 27, wherein the required power is at least about 3.6 to about 4 V.

29. The apparatus of claim 27, wherein the circuit is adapted to deliver at least about 3.6 to about 4 V to the one or more light emitting diodes when power at the port varies from about 3.2 V to about 5 V.

30. The apparatus of claim 27, wherein the circuit is adapted to deliver at least about 3.6 to about 4 V to the one or more light emitting diodes when power at the port is about 3.2 V.

31. The apparatus of claim 27, wherein the circuit is adapted to deliver at least about 3.6 to about 4 V to the one or more light emitting diodes when power at the port is about 5 V.

32. The apparatus of claim 27, wherein the circuit is adapted to deliver at least about 3.6 to about 4 V to the one or more light emitting diodes when power at the port is less than 3.6 V.

33. The apparatus of claim 27, wherein the circuit is adapted to deliver at least about 3.6 to about 4 V to the one or more light emitting diodes when power at the port is at least about 0.8 V.

34. The apparatus of claim 27, wherein the hand held portable video game device has a non-backlit display screen.

35. The apparatus of claim 27, wherein the circuit includes an inductive storage device, a switching regulator device, a rectifier, a filter, and a current sensing device.

36. The apparatus of claim 35, wherein said inductive storage device is wire wound with an inductance between about 22 and 220 micro henries.

37. The apparatus of claim 35, wherein said switching regulator device comprises: a reference voltage source; an oscillation circuit; an error amplifier; and a power MOSFET.

38. The apparatus of claim 35, wherein said switching regulator device is a CMOS PWM-PFM-control step-up switching regulator.

39. The apparatus of claim 35, wherein said rectifier is a Schottky diode.

40. The apparatus of claim 35, wherein said current sensing device is a current driver and temperature compensation circuit comprising an error amplifier, a current sensing resistor and at least two reference voltage resistors.

41. The apparatus of claim 40, wherein said current driver and temperature compensation circuit further comprises a transistor as a power driver.

42. The apparatus of claim 35, further comprising a low voltage power converter circuit.

43. The apparatus of claim 42, wherein said low voltage power converter circuit produces 3 volts and 20 milliamps when supplied with at least 0.8 volts input.

44. The apparatus of claim 42, wherein said switching regulator device comprises: a programmable reference voltage source; an oscillation circuit; and an error amplifier.

45. The apparatus of claim 44, further comprising a super enhanced MOSFET.

46. The apparatus of claim 27, wherein said circuit is at least about 70% to about 99 % efficient.

47. The apparatus of claim 27, wherein said circuit is at least about 90% efficient.

48. The apparatus of claim 27, wherein said circuit is at least about 97% efficient.

49. The apparatus of claim 45, wherein said inductive storage device is wire wound with an inductance between about 22 and 220 micro henries, said switching regulator device is a CMOS PWM/PFM-control step-up switching regulator, said rectifier is a Schottky diode, and said current sensing device is a current driver and temperature compensation circuit comprising an error amplifier, a current sensing resistor, at least two reference voltage resistors, and a transistor as a power driver.

50. The apparatus of claim 45, wherein said switching regulator device comprises a programmable reference voltage source, an oscillation circuit, and an error amplifier, and said circuit further comprises a low voltage power converter circuit capable of producing 3 volts and 20 milliamps when supplied with a least 0.8 volts input and a super enhanced MOSFET.

51. The apparatus of claim 27, wherein the one or more light emitting diodes includes one or more white light emitting diodes.

52. An apparatus for use with a portable electronic or computing device having a port in electrical connection with a power source for delivering power through the port, comprising:
a plug for plugging the apparatus into the port;
an electrical load connected to the plug and to be electrically connected to the port through the plug, the electrical load requiring a required power to drive the load effectively, the electrical load being powered by the power source when the apparatus is plugged into the port; and
a circuit to deliver the required power to the electrical load regardless of the power delivered at the port.
